(19) United States
(12) Patent Application Publication
(10) Pub. No.: US 2011/0212245 A1
(43) Pub. Date: Sep. 1, 2011

(54) BEVERAGE COMPOSITION AND METHOD OF MAKING SAME

(76) Inventor: David P. Volk, Virginia Beach, VA (US)

(21) Appl. No.: 12/362,554

(22) Filed: Jan. 30, 2009

(51) Int. Cl. C12G 3/04

(52) U.S. Cl. 426/592

(57) ABSTRACT

A beverage composition that is a twist on the traditional Margarita includes tequila, triple sec liqueur, limeade concentrate and lime sherbert. To create the composition, ingredients of tequila, triple sec, frozen limeade concentrate and lime sherbert are added to a blender to form a slurry, and ice is then added into the slurry. The slurry is blended until the composition is achieved with a desired viscosity.

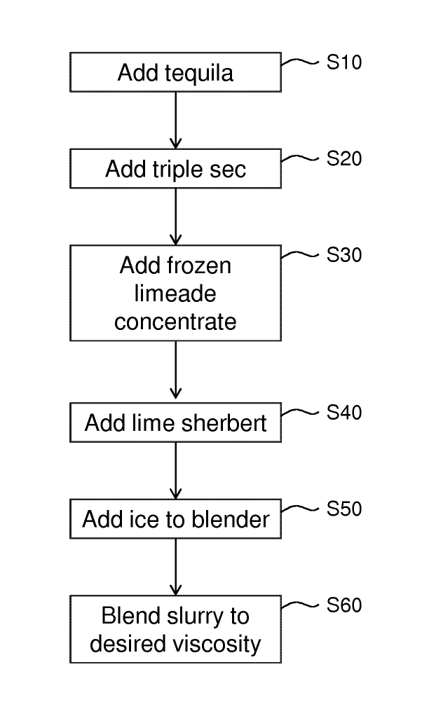

### BACKGROUND

1. Field of the Invention

Example embodiments in general are directed to a beverage composition and to a method of making the beverage composition.

2. Description of Related Art

The traditional Margarita cocktail is generally comprised of a combination of tequila, triple sec and lime juice. To make the cocktail, these ingredients are combined in desired proportions so as to satisfy the consumer. Additionally, off-the-shelf pre-made margarita mixes exist for purchase by the consumer to combine with tequila in a desired ratio.

### SUMMARY

An example embodiment of the present invention is directed to a beverage composition. The composition includes tequila, triple sec liqueur, limeade concentrate and lime sherbert.

Another example embodiment is directed to a method of making a beverage composition. In the method, ingredients of tequila, triple sec, frozen limeade concentrate and lime sherbert are poured into a blender, and then a quantity of ice is added to the slurry in the blender. The slurry is then blended until the composition is achieved with a desired viscosity.

Another example embodiment is directed to a beverage composition. The composition includes tequila, triple sec, a frozen concentrate and sherbert.

### BRIEF DESCRIPTION OF THE DRAWING

Example embodiments will become more fully understood from the detailed description given herein below and the accompanying drawing, wherein like elements are represented by like reference numerals, which are given by way of illustration only and thus are not limitative of the example embodiments herein.

The sole FIGURE is a flowchart for illustrating a method of making a beverage in accordance with the example embodiments.

### DETAILED DESCRIPTION

As set forth below, the example embodiments are directed to a beverage composition that is a variation of the Margarita cocktail and to a method of making the beverage composition. Example ingredients for the composition include a combination of concentrated limeade, tequila, a triple sec liqueur and a sherbert (also referred to or known as a sherbet or sorbet). The limeade may be derived from frozen concentrate.

As an example, the tequila selected for the composition may be a premium brand such as JOSE CUERVO GOLD®. The triple sec liqueur used could be a premium brand such as COINTREAU®. Additionally, “off-the-shelf” limeade products such as the frozen limeade concentrate sold under the MINUTEMAID® label may be used for the beverage composition. The sherbert may be a lime sherbert, for example.

Each of the foregoing ingredients may be combined in a proportion between 19.5 to 25.5% by volume. As an example, and for purposes of batch processing, each of the ingredients have been used in the proportions of 4.5 to 7.5 ounces each (18 to 30 oz batch), yielding three to five 6 oz. servings of the resultant beverage. It is evident that greater or lower proportions of each ingredient could be combined to make the desired size batch.

The sole FIGURE is a flowchart for illustrating a method of making a beverage in accordance with the example embodiments. For purposes of explanation only so as not to limit the scope of the example embodiments, the method is described with regard to preparation of an approximately 24 ounce batch of the beverage composition with equal parts of all ingredients.

Referring to the Figure, to prepare the beverage composition, the following steps S10 to S40 could be performed in any order; one example is provided. Into a blender, 6 oz. each of tequila (S10), triple sec (S20), frozen limeade concentrate (S30) and lime sherbert (S40) may be added to form a slurry. Next, a given quantity of ice is added (S50) to the slurry in the blender. The amount of ice is variable depending on the size of the blender mixing container. In an example, the ice is added to completely fill the blender container. In another example, the ice is made from conventional home refrigeration system with ice makers, although dedicated ice machines and store-bought cube ice could serve as alternative ices sources.

An example volume of the blender may be a container having a volume of at least 40 ounces. The power rating of the blender may be variable. A rating at least 500 W is recommended to achieve the desired viscosity when blending the slurry that ultimately forms the resultant beverage composition.

The slurry is then blended (S60) for a given duration to achieve the desired viscosity of the resultant beverage. Optionally, salt around the rim of the consumer's drinking article and a garnish may be added as desired. The beverage composition is a unique twist on the standard Margarita, and may be served to consumers as a cocktail or dessert for example.

The example embodiments being thus described, it will be obvious that the same may be varied in many ways. The beverage cocktail herein has been described as including a frozen limeade concentrate and a lime sherbert. However, the example embodiments are not limited: the frozen concentrate may any other fruit-based or artificial fruit-flavored concentrate in lieu of the lime flavor. Similarly, the sherbet may any other fruit-based or artificial fruit-flavored sherbet besides lime sherbert. Such variations are not to be regarded as departure from the example embodiments, and all such modifications as would be obvious to one skilled in the art are intended to be included herein.

What is claimed is:

1. A beverage composition, comprising:
tequila,
triple sec liqueur,
limeade concentrate, and
lime sherbert.

2. The composition of claim 1, wherein the tequila, triple sec, limeade concentrate and lime sherbert are combined in substantially equal proportions.

3. The composition of claim 1, wherein each of the tequila, triple sec, limeade concentrate and lime sherbert is combined in a proportion between 19.5 to 25.5%.

4. The composition of claim 1, wherein the limeade concentrate is a frozen limeade concentrate.

5. The composition of claim 1, wherein the tequila, triple sec, limeade concentrate and lime sherbert forms a frozen slurry mixture.

6. The composition of claim 1, wherein the tequila, triple sec, limeade concentrate and lime sherbert are combined to form a batch quantity in which each proportion is between 4.5 to 7.5 ounces.

7. The composition of claim 1, further comprising ice.

8. The composition of claim 1, wherein the tequila is JOSE CUERVO GOLD®.

9. The composition of claim 1, wherein the triple sec is COINTREAU®.

10. A method of making a beverage composition, comprising:
pouring ingredients of tequila, triple sec, frozen limeade concentrate and lime sherbert into a blender,
adding a quantity of ice to the blender, and
blending the ice and ingredients until the composition is achieved with a desired viscosity.

11. The method of claim 10, wherein pouring further includes combining the ingredients in substantially equal proportions in the blender.

12. The method of claim 10, wherein each of the ingredients is combined in a proportion between 19.5 to 25.5%.

13. The method of claim 10, wherein pouring further includes combining the ingredients to form a batch quantity in the blender where each proportion is between 4.5 to 7.5 ounces.

14. The method of claim 10, wherein the resultant beverage composition is a frozen slurry mixture.

15. A beverage composition, comprising:
tequila,
triple sec liqueur,
a frozen concentrate, and
sherbert.

16. The composition of claim 15, wherein the frozen concentrate is a fruit-based frozen concentrate.

17. The composition of claim 15, wherein the frozen concentrate is an artificial fruit-flavored frozen concentrate.

18. The composition of claim 15, wherein the sherbert is a fruit-based sherbert.

19. The composition of claim 15, wherein the sherbert is an artificial fruit-flavored sherbert.

20. The composition of claim 15, wherein the tequila is JOSE CUERVO GOLD® and the triple sec is COINTREAU®.
